(19) United States
(12) Patent Application Publication
(10) Pub. No.: US 2007/0220413 A1
(43) Pub. Date: Sep. 20, 2007

(54) Method and computer medium for organising URLs for affiliate referrals

(76) Inventor: Robert Irven Beaver III, Redwood City, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/701,609

(22) Filed: Feb. 1, 2007

Related U.S. Application Data
(60) Provisional application No. 60/764,953, filed on Feb. 2, 2006.

(51) Int. Cl. G06F 17/00

(52) U.S. Cl. 715/501.1

(57) ABSTRACT

A method of organizing a URL string and a computer readable medium encoding the referral of a visitor to a merchant website by an affiliate having a presence on the merchant website comprising attaching a token to the URL string of the merchant website, the token capable of being combined with an affiliate identifier to form a mnemonic representation of the affiliate's presence on the merchant website and comprised of at least one character not have an established meaning when used as a part of the URL string and distinct from the affiliate identifier. The tokens are selected from the group consisting of “*” and “!”.

The present invention relates to a method and computer medium for organizing a URL string to designate the referral of a visitor to a merchant website by an affiliate having a presence on the website in order to compensate the affiliate for the referral. The present application claims the benefit of, and hereby incorporates by reference, U.S. Provisional Patent Application 60/764.953, entitled “Zazzle Star Patent Description”, filed Feb. 2, 2006.

### BACKGROUND

A Uniform Resource Locator (URL) is a method by which documents or data are addressed on the Internet. A URL may contain the following information:
The type of service the resource is served by (usually HTTP)
The Internet host that the resource is served by (usually the name of the website)
The location of the resource on the host (usually hierarchical and separated by ‘/’ characters)
A set of arguments to pass to the host usually referred to as query-string parameters.

The general format is to append the arguments to the end of the URL, separated from the rest of the URL by a ‘?’ character.

An example outline of the most common form of a URL is shown in FIG. 1 indicating the portions of a sample URL which are the type of service, the host, the location of the resource and the query-string parameters. This example and all other examples and hyperlinks referenced in this application are fakes and cannot become a live web link. For example, the second letter of a normal word in the host will be triplicated.

On the Internet, it is common practice for a website to provide consideration to other websites that refer visitors. A website that rewards other websites that refer visitors is typically called an advertiser or merchant. A website that refers visitors to another in return for consideration is typically called an affiliate.

These arrangements are commonly referred to as affiliate programs. An affiliate program is a form of advertising on the Internet that rewards affiliates for referring visitors to advertisers/merchants. These programs are generally offered by websites selling goods or services.

Affiliates receive consideration for certain defined actions by a referred visitor on an advertiser's website. The affiliate program defines the actions that receive consideration and the time periods in which these actions must occur in order to receive consideration. These visitor actions are typically purchases, registrations, or the visits themselves. For example, an advertiser may agree to pay an affiliate 5% of every purchase by a visitor referred by the affiliate if the purchase occurs within 30 days of the referral.

As shown in FIG. 2 affiliates 10 refer visitors 14 at affiliate website 11 on to advertiser-merchant 16 by means of a URL that directs visitor 14 to a location on advertiser's website 17. In addition to a specific location, the URL must also convey that visitor 14 was referred, and it must identify affiliate 10 responsible for the referral. There are two current URL constructs used to identify the referring affiliate 10. The first identifies affiliate 10 in the URL query-string and the second identifies affiliate 10 in the URL path.

The most common URL construct used in affiliate programs is to identify the affiliate 10 in the URL query-string. In order to identify each affiliate 10, advertiser 16 assigns each affiliate 10 a unique identifier. Once assigned an identifier, each affiliate 10 must include its identifier in the query-string of the URL they use to refer visitors 14 to advertiser 16.

For example, if affiliate 10 wishes to link visitor 14 to advertiser 16 URL “http://www.adddvertiser.com” at the advertiser website 17 as shown in FIG. 2, affiliate 10 would typically have to include its unique identifier in the URL query-string as follows: “http://www.adddvertiser.com?affiliate_id=affiliate”. When advertiser 16 detects a possible referral, advertiser 16 must determine if an affiliate identifier is included in the URL query-string in order to determine if visitor 14 was referred, and, if so, which affiliate 10 was responsible for the referral.

An alternative URL construct used by affiliate programs is to identify affiliate 10 in the URL path instead of the URL query-string. Just as in the first construct, advertiser 16 assigns each affiliate 10 a unique identifier. Each affiliate 10 must include its identifier in the path of the URL they use to refer visitors 14 to advertiser 16.

Websites of varying types can offer individuals, groups, organizations, and corporations the ability to create and maintain separate presences within the larger website. For example, many social networking websites allow their users to create homepages that they can personalize with their own content. In an effort to create a strong association between these users and their separate presences, websites often create a simple URL for each user that leverages their unique user name and addresses the location of their presence. The two most common URL constructs are “http://www.siiite.com/username” and “http://username.siiite.com”. In the social networking example above, either of these two URL constructs may link to a user's homepage. Generally speaking, these constructs are easy to read, easy to understand, and easy to propagate.

### SUMMARY OF THE INVENTION

In accordance with the present invention a method of organizing a URL and a computer readable medium are provided in an affiliate host system for presenting a user link to an advertiser-merchant website in which the affiliate has a presence and attaching to the merchant URL which contains an affiliate identifier a token which automatically designates to the advertiser-merchant the affiliate as the referrer of the user for a commission from the merchant.

The token can be comprised of many different forms and can be applied in many different locations. The token can contain up to several possible characters selected from the letters, numbers and/or key symbols which do not have an established meaning when used in a URL and which are distinct from the affiliate identifier.

A feature of the invention is that the token can be located anywhere in the host, the location of the resource or the query-string portions of the URL.

Preferred tokens include “*” and “!“and combinations thereof such as “**”, “!!”, “*!”, “!*” etc.

### BRIEF DESCRIPTION OF THE DRAWINGS

FIG. 1 is an outline of the most common form of URL currently in use wherein the common elements are bracketed with an indication there below of the description of the respective elements

FIG. 2 is a block diagram of an exemplary system for generating a commission in an advertiser-merchant administered affiliate program.

FIG. 3 is a block diagram illustrating the present invention.

FIG. 4 is a listing of example permutations of the use of tokens in URLs in accordance with the present invention.

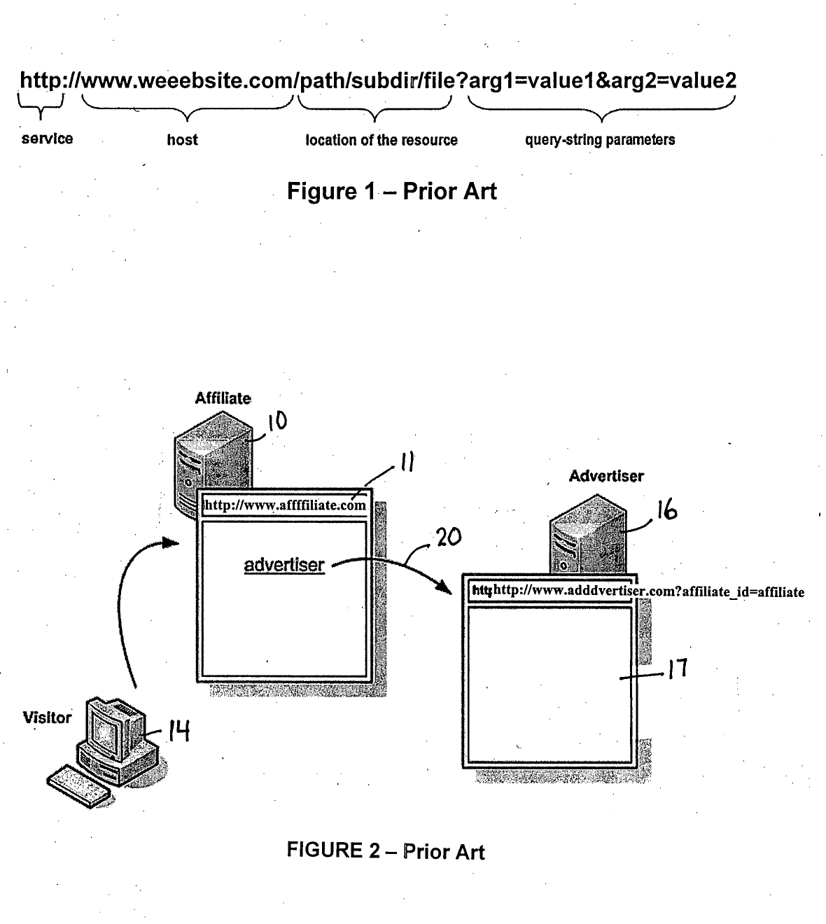

### DETAILED DESCRIPTION

An embodiment of the present invention provides a method of organizing a URL string encoding the referral of a visitor to a merchant website by an affiliate having a presence on the merchant website comprising attaching a token to the URL string of the merchant website, the token capable of being combined with an affiliate identifier to form a mnemonic representation of the affiliate's presence on the merchant website and comprised of at least one character not have an established meaning when used as a part of the URL string and distinct from the affiliate identifier.

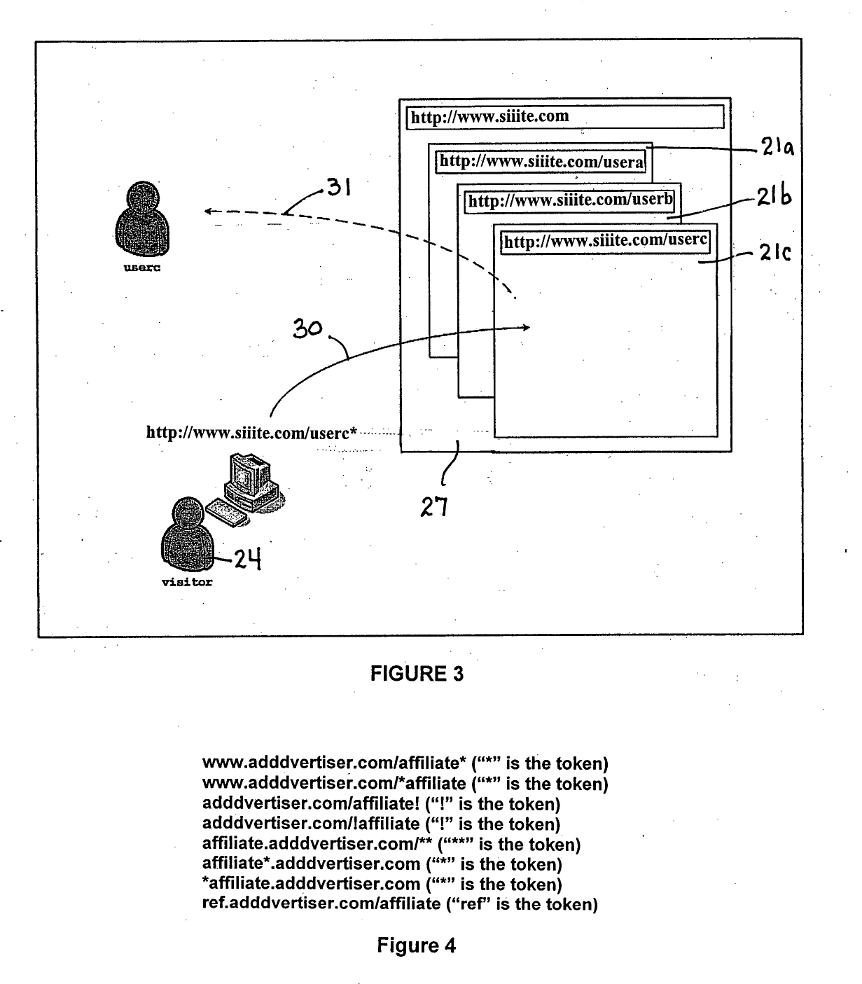

Referring now to FIG. 3, there is shown the advertiser-merchant website 27 in which affiliate-users a, b, and c have a presences 21a, 21b and 21c and addresses containing the merchant URL and their own identities “usera”, userb” and “userc”. A visitor 24 has access to the URL of the merchant site 27 and the identifier of an affiliate, such as “userc”. The visitor either types in that URL combination “http://www.siiite.com/userc*” including the token“*” directly into his/her browser or is linked to that URL combination by some means and is directed at 30 to the user-affiliate's presence 21c on the site. The special token “*” in the URL signifies to the site to track the visitor's visit as being referred by the user-affiliate.

The token can be comprised of many different forms and can be applied in many different locations. The token can contain up to several possible characters selected from the letters, numbers and/or key symbols which do not have an established meaning when used in a URL and which are distinct from the affiliate identifier. Preferred tokens include “*”, “!” and combinations thereof because they best stand out and will be recognized. A feature of the invention is that the token can be located anywhere in the host, the location of the resource or the query-string portions of the URL.

In the typical case where an affiliate is linking to an advertiser, the URL might be of the form, “http://www.adddvertiser.com?affiliate_id=affiliate” or “http://www.adddvertiser.com/affiliate_id-affiliate”. In the case where an affiliate is linking to a presence on the advertiser's website, the URL might be of the form, “http://www.adddvertiser.com/presence?affiliate_id=affiliate” or “http://www.adddvertiser.com/presence/affiliate_id-affiliate”. In the special case described above, where an affiliate is linking to its own presence on the advertiser's website, the URL might be of the form, “http://www.adddvertiser.com/affiliate?affiliate_id=affiliate” or “http://www.adddvertiser.com/affiliate/affiliate_id-affilate”.

In the present invention the special token eliminates the use of the redundant affiliate identifier. This special token conveys to the advertiser that the single affiliate identifier is to be used both as the location of the affiliate's presence and as the affiliate's identity as the referrer. For example, if the token were the ‘*’ character, the invention could provide for a URL of the form, “http://www.adddvertiser.com/affiliate*”.

In addition, an advertiser can support multiple tokens and applications within the URL. Some example permutations are provided below and shown in FIG. 4.
www.adddvertiser.com/affiliate* (“*” is the token)
www.adddvertiser.com/*affiliate (“*” is the token)
adddvertiser.com/affiliate! (“!” is the token)
adddvertiser.com/!affiliate (“!” is the token)
affiliate.adddvertiser.com/** (“**” is the token)
affiliate*.adddvertiser.com (“*” is the token)
*affiliate.adddvertiser.com (“*” is the token)

The key benefits of this method and computer readable medium for referrals are that the resultant referral URL is shorter, more intuitive, and easier to remember. The improved nature of the URL makes it much easier to propagate both on and off the Internet. This simple URL construct lends itself to materials such as flyers, newsletters, business cards, stickers, as well as the spoken word. As a result, this URL construct engenders much easier and effective promotion in comparison to other constructs used to identify referring affiliates. As such, the affiliate is increasingly empowered to distribute its reach and the advertiser benefits as a direct result.

The token and affiliate identifier in effect encodes the presence of the affiliate into the URL string by forming a simplified mnemonic which in turn aids in the propagation of the website by advertising means. It should be generally understood that such advertising means include brochures, pamphlets, conversation, as well as electronic distribution of information.

With the above embodiments in mind, it should be understood that, the invention may be practiced with other computer system configurations including hand-held devices, microprocessor systems, microprocessor-based or programmable consumer electronics, minicomputers, mainframe computers and the like. Furthermore, the invention may employ various computer-implemented operations involving data stored in computer systems. These operation are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which thereafter be read by a computer system. Examples of the computer readable medium include hard drives, network attached storage (NAS), read-only memory, random-access memory, CD-ROM's, CD-Rs, CD-RWs, magnetic tapes, and other optical and non-optical data storage devices. The computer readable medium can also be distributed over a network coupled computer systems so that the computer readable code is stored and executed in a distributed fashion. Furthermore, although the present invention implements Java programming language, other programming languages may be used to implement the embodiments of the present invention (e.g., C, C.sub.++, any object oriented programming language, etc.).

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified with the scope and equivalents of the appended claims.

What is claimed is:

1. A method of organizing a URL string encoding the referral of a visitor to a merchant website by an affiliate having a presence on the merchant website comprising:
attaching a token to the URL string of the merchant website, the token capable of being combined with an affiliate identifier to form a mnemonic representation of the affiliate's presence on the merchant website and comprised of at least one character not have an established meaning when used as a part of the URL string and distinct from the affiliate identifier.

2. The method of claim 1 wherein said token is located anywhere in the host, the location of the resource or the query-string of the URL.

3. The method of claim 1 including selecting said token from the group consisting of “*” and “!”.

4. The method of claim 1 wherein the token is comprised of at least one “*” character.

5. The method of claim 1 wherein said token is comprised of at least one “!” character.

6. The method of claim 1 wherein the mnemonic representation of the affiliate's presence on the merchant website forms a name.

7. The method of claim 1 wherein the mnemonic representation of the affiliate's presence on the merchant website forms a word.”.

8. A computer readable medium having computer executable instructions thereon for organizing a URL string encoding the referral of a visitor to a merchant website by an affiliate having a presence on the merchant website, the method comprising:
attaching a token to the URL string of the merchant website, the token capable of being combined with an affiliate identifier to form a mnemonic representation of the affiliate's presence on the merchant website and comprised of at least one character not have an established meaning when used as a part of the URL string and distinct from the affiliate identifier.

9. The computer readable medium of claim 8 wherein said token is located anywhere in the host, the location of the resource or the query-string of the URL.

10. The computer readable medium of claim 8 including selecting said token from the group consisting of “*” and “!”.

11. The computer readable medium of claim 8 wherein said token is comprised of at least one “*” character.

12. The computer readable medium of claim 8 wherein said token is comprised of at least one “!” character.

13. The computer readable medium of claim 8 wherein the mnemonic representation of the affiliate's presence on the merchant website forms a name.

14. The computer readable medium of claim 8 wherein the mnemonic representation of the affiliate's presence on the merchant website forms a name.

15. A method of designating a visit to a merchant website, comprising:
receiving an indication that a visitor is accessing a merchant website using a URL string wherein the merchant website includes an identifier of an affiliate having a presence on the website;
identifying a presence of a toke in the URL string; and
based on the presence of the token, designating the visit as a referral to the merchant website from the affiliate;
wherein the token comprises a character or sequence of characters which do not have an established meaning when used in a URL and which are distinct from an affiliate identifier.

16. The method of claim 15, wherein an affiliate having a presence on the website.

17. The method of claim 15 further including compensating the affiliate for the referral.

18. The method of claim 15 including designating the referral as being from an affiliate having a presence on the website.

19. The method of claim 15 wherein the referral is used to track referrals to the merchant website.
